(19) United States
(12) Patent Application Publication
(10) Pub. No.: US 2012/0159190 A1
(43) Pub. Date: Jun. 21, 2012

(54) ENCRYPTION DEVICE, DECRYPTION DEVICE, ENCRYPTING METHOD, AND DECRYPTING METHOD

(75) Inventor: Taizo Anan, Kawasaki (JP)

(73) Assignee: Fujitsu Limited, Kawasaki (JP)

(21) Appl. No.: 13/402,237

(22) Filed: Feb. 22, 2012

Related U.S. Application Data
(63) Continuation of application No. PCT/JP2009/004326, filed on Sep. 2, 2009.

(51) Int. Cl. G06F 21/24; G06F 17/00

(52) U.S. Cl. 713/189

(57) ABSTRACT

An identification information setting unit of an encryption device on document data determines whether or not an encrypted area has been divided by an editing operation of document data, and sets identification information indicating any position of four corners of an undivided encrypted area at a corresponding position of each divided encrypted area when the encrypted area has been divided.

### CROSS-REFERENCE TO RELATED APPLICATIONS

This application is a continuation application of International PCT Application No. PCT/JP2009/004326 which was filed on Sep. 2, 2009.

### FIELD

The following embodiments relate to an encryption device, a decryption device, an encrypting method, and a decrypting method.

### BACKGROUND

There is document editing software having the function of displaying document data with a part of the data painted black.

FIG. 1B is an example of painting black a part of the document data illustrated in FIG. 1A using the document editing software. When a character is added before or after the black painted portion, the entire layout is destroyed as illustrated in FIG. 1C. In addition, with this type of software, the black painted area cannot be decrypted to the original state.

There is a technology of designating the encrypting position of a digital image by adding positioning markers for designation of an encrypting position to at least two or more in the four corners of an encrypted area using the encryption device for encrypting a digital image (for example, the patent document 1). There is also the technology of decrypting an encrypted image area to a digital image.

According to the technology above, after printing an encrypted document image on paper, the image can be fetched to a personal computer by a scanner etc. to decrypt the document image.

### DOCUMENT OF PRIOR ART

### Patent Document

[Patent Document 1] Japanese Laid-open Patent Publication No. 2008-301044

FIG. 3 is an encrypted part of the document data illustrated in FIG. 2. FIG. 4 is an example of the case in which the characters “In the Japanese market,” are added to the encrypted area illustrated in FIG. 3. In this case, the encrypted area is divided into two sections by editing the document data.

When the document data in FIG. 4 is printed, and the printed document image is read by a scanner and decrypted, the encrypted area on the right which is not divided as illustrated in FIG. 5 can be correctly decrypted, but the encrypted area on the top which has been divided is unsuccessfully decrypted.

### SUMMARY

The disclosed encryption device includes: an encrypted area detection device for detecting an encrypted area from document data; and an identification information setting device for determining whether or not the encrypted area has been divided by an editing operation on the document data, and setting identification information indicating any position of the four corners of an undivided encrypted area at a corresponding position of each of the divided encrypted areas if the encrypted area has been divided.

The disclosed decryption device includes: an encrypted area detection device for detecting an encrypted area from document data; a determination device for determining whether or not an area is a divided encrypted area depending on whether or not identification information indicating any position of four corners of an undivided encrypted area is arranged at a corner of the encrypted area detected by the encrypted area detection device and information different from the identification information is arranged at other corners; and a decryption device for combining a plurality of encrypted areas divided according to the identification information indicating any position of the four corners when the determination device has determined the divided encrypted area, and decrypting the combined encrypted areas.

With the disclosed encryption device, for example, an encrypted area can be distributed so that, for example, an image can be correctly decrypted after it is converted into a document image. Furthermore, with the disclosed decryption device, an encrypted area obtained by dividing a document image can be decrypted.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A through 1C are an example of a part of document data painted;

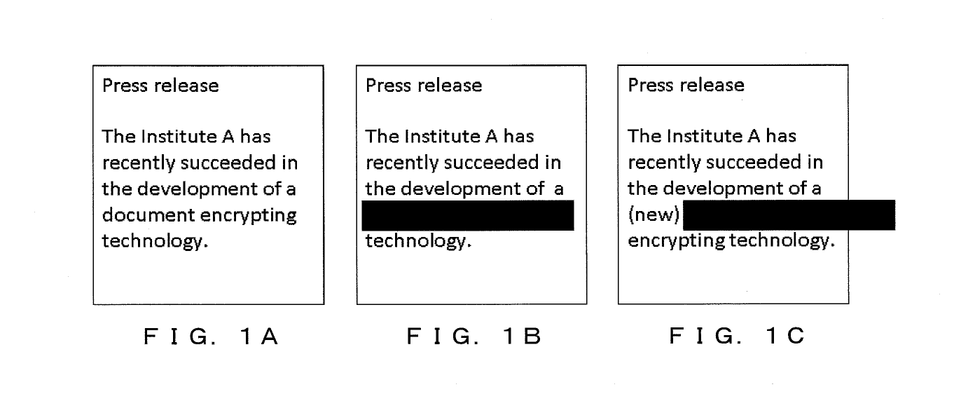

FIG. 2 is an example of document data

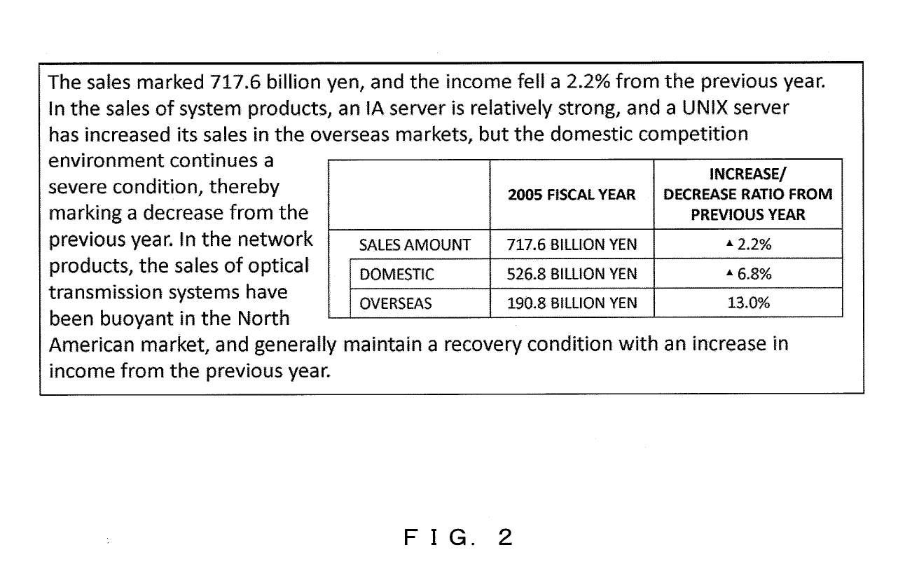

FIG. 3 illustrates document data a part of which is encrypted;

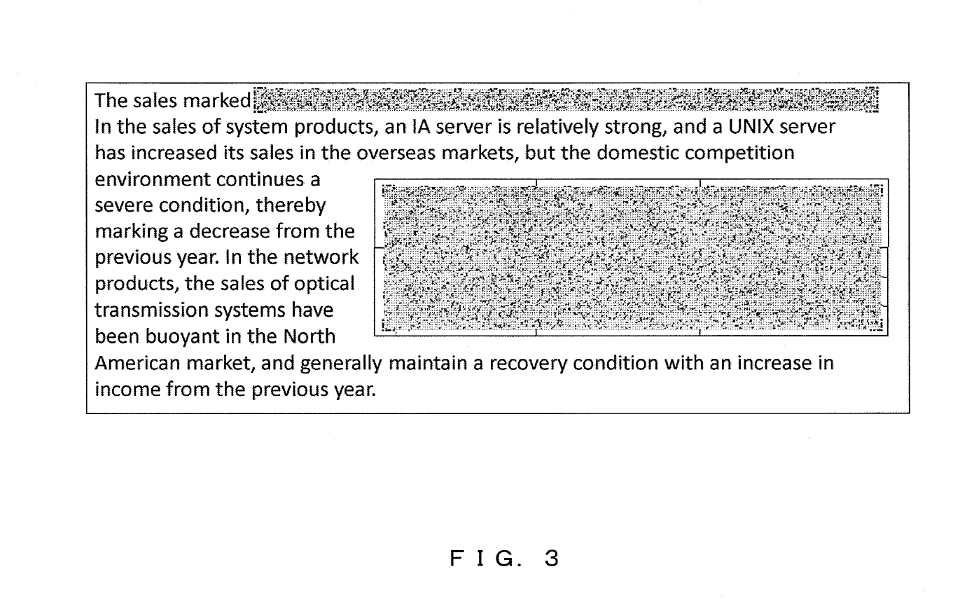

FIG. 4 illustrates document data in which an encrypted area is distributed;

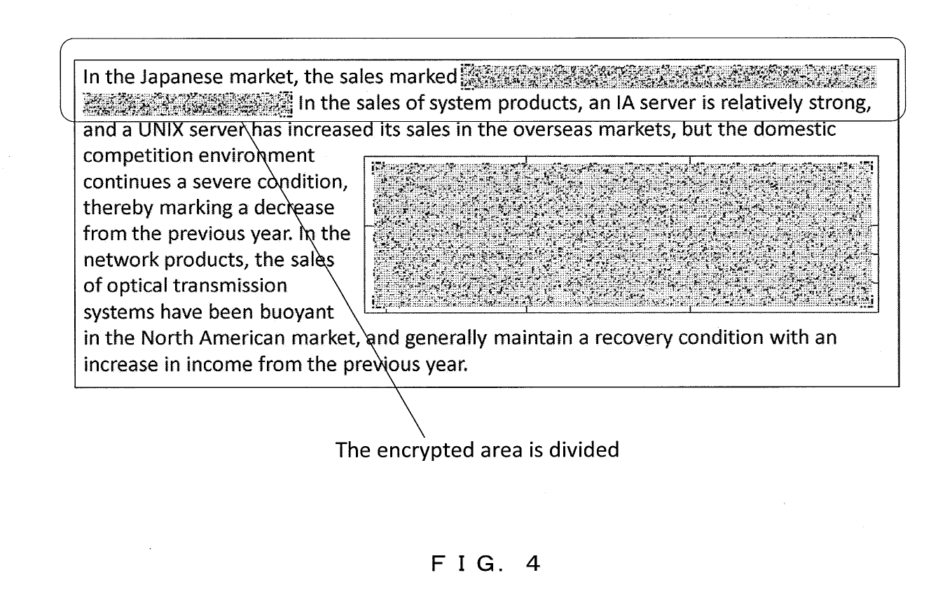

FIG. 5 is an example of the case in which a divided encrypted area is unsuccessfully decrypted;

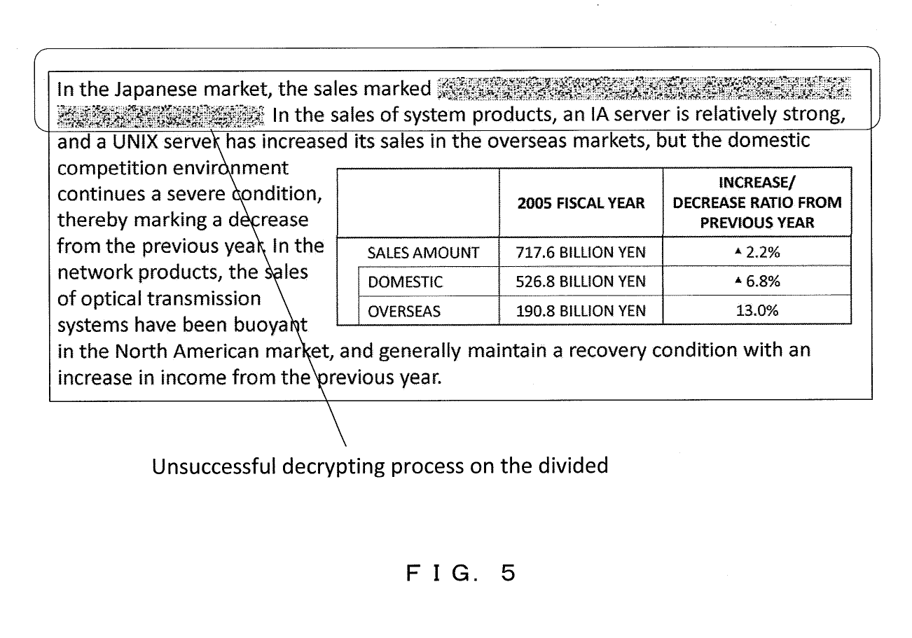

FIG. 6 is a configuration of the encryption device according to the first embodiment;

FIG. 7 is an example of a management table;

FIG. 8 is an explanatory view of dividing an encrypted area;

FIG. 9 is an explanatory view of a marker arranged at a divided area;

FIG. 10 is a flowchart of an encrypting process;

FIGS. 11A through 11F are an example of a divided encrypted area;

FIGS. 12A through 12C are an example of data of a management table;

FIG. 13 is a configuration of an information processing device implemented with an encrypting program of document data;

FIG. 14 is a configuration of the decryption device according to the second embodiment;

FIGS. 15A and 15B illustrate markers arranged at divided encrypted areas and recombined encrypted areas;

FIG. 16 is a flowchart of a decrypting process;

FIGS. 17A through 17G are an explanatory view of the process contents of the decrypting process when hooked markers and linear markers are added to the corners of an encrypted area;

FIG. 18 is a configuration of an information processing device implemented with a decrypting program;

FIGS. 19A through 19C are an example of the case in which an encrypted area is divided into five or more areas;

FIG. 20 is an example of the case in which divided encrypted areas are recombined and decrypted;

FIG. 21 is an example of the case in which characters of divided encrypted areas are decrypted and displayed in another window; and

FIG. 22 is an example of the case in which decrypted characters are divided again and applied.

### DESCRIPTION OF EMBODIMENTS

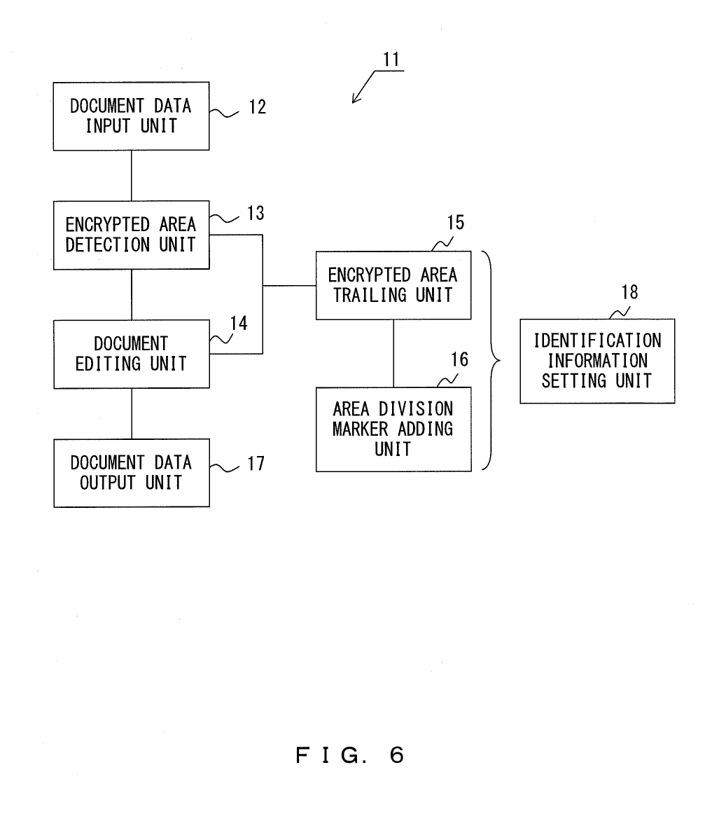

Described below are preferable embodiments of the present invention. FIG. 6 is a configuration of the encryption device of document data according to the first embodiment.

An encryption device 11 includes a document data input unit 12, an encrypted area detection unit 13, a document editing unit 14, an encrypted area trailing unit 15, an area division marker adding unit 16, and a document data output unit 17.

The document data input unit 12 is to fetch document data to the device. The document data input unit 12 is, for example, an optical reader such as a scanner etc. for reading a printed document image or an input unit for inputting a character code etc. of document data. The document data input unit 12 has a storage device etc., and the input document data is stored in the storage device.

The encrypted area detection unit 13 detects an encrypted area by detecting data (identification information, for example, a marker, a code, etc.) added to the four corners of the encrypted area in the document data.

The encrypted area detection unit 13 associates the area ID for designation of the detected encrypted area, the coordinates data of each character of the encrypted area, and the data indicating any position of the four corners of the encrypted area, and stores the associated data in a management table. The functions of generating and updating the management table of the encrypted area detection unit 13 correspond to, for example, the management table generation unit.

In the present embodiment, when a part of area of the document data is encrypted, the identification information (for example, markers different in shape) indicating any position of the four corners is added to the corners of the area which has been encrypted (hereafter referred to as an encrypted area). Therefore, the encrypted area can be detected by detecting the identification information.

The document editing unit 14 edits document data, adds and changes an encrypted area, etc. according to an instruction of a user input from a keyboard etc.

The encrypted area trailing unit 15 monitors whether or not the document editing unit 14 has changed an encrypted area by adding, dividing, combining, etc. of the area. If it detects an addition, a division, or a combination of the encrypted area, it updates the data of the management table. The practical configuration of the management table is described later.

The area division marker adding unit 16 sets (or arranges) the markers indicating any area of the four corners of the undivided encrypted area at a corresponding position of the divided encrypted area. The markers added to the corners of the undivided encrypted area are set as is. Furthermore, the markers different from the markers above are set (or arranged) at other corners of the divided encrypted areas. The area division marker adding unit 16 calculates the coordinates of the divided encrypted area, and the calculated coordinates data is added to the management table. The encrypted area trailing unit 15 and the area division marker adding unit 16 correspond to, for example, an identification information setting unit (identification information setting device).

For example, when the divided encrypted area is an area including the upper left corner of the undivided encrypted area, the area division marker adding unit 16 sets (or arranges) a marker (for example, an upper left hooked marker) capable of identifying the position at the upper left corner position of the divided encrypted area. When the divided encrypted area is an area including the upper right corner of the undivided encrypted area, the area division marker adding unit 16 sets a marker (for example, an upper right hooked marker) capable of identifying the position at the upper right corner position of the divided encrypted area. Similarly, for the areas including the lower left corner and the lower right corner, the markers capable of identifying the lower left corner area and the lower right corner area are arranged.

The markers capable of identifying the positions of the upper left corner, the lower left corner, the upper right corner, the lower right corner are added when an encrypted area is generated.

The document data output unit 17 is a display device for display of an edition result of document data, a printer device for printing the document data, etc.

FIG. 6 illustrates the encrypted area trailing unit 15 and the area division marker adding unit 16 in the different blocks, but their functions can be combined into one unit. For example, it is also possible to realize as an identification information setting unit 18 the function of determining whether or not an encrypted area has been determined, and then setting a marker indicating any position of the four corners of the undivided encrypted area at the corresponding position of each of the divided encrypted areas.

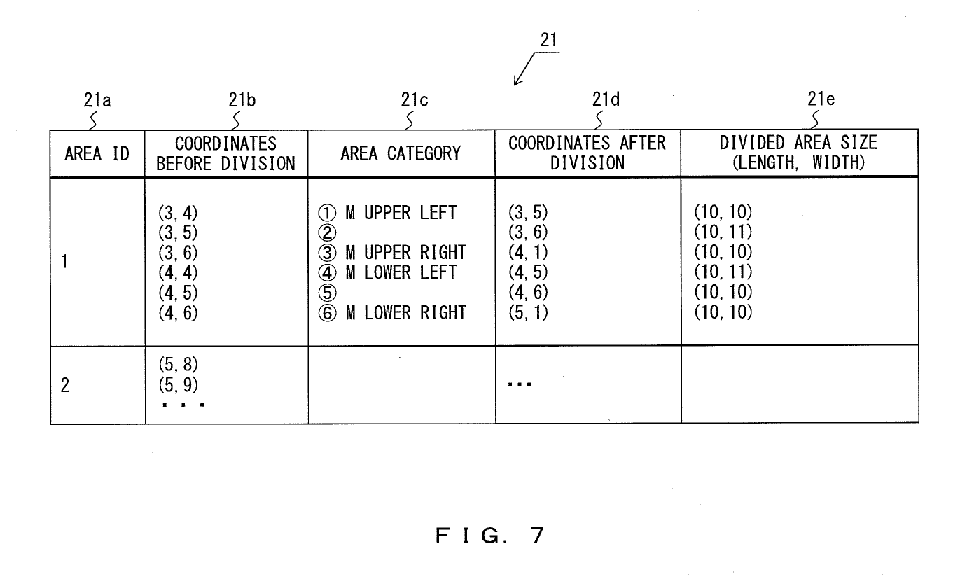

FIG. 7 is an example of a management table 21 storing the data of an encrypted area.

The management table 21 includes a memory area 21a storing an area ID, a memory area 21b storing the coordinates data of a character area of an undivided encrypted area, and a memory area 21c storing the data (area category) indicating any position of the four corners. The management table 21 is also provided with a memory area 21d storing the coordinates data after a division, and a memory area 21e storing the divided area size (size of each character area).

The memory area 21d storing the area category of the management table 21 stores the data “M” indicating a corner, and the data indicating any of the four corners, “upper left”, “upper right”, “lower left”, and “lower right” as the data indicating any position of the four corners.

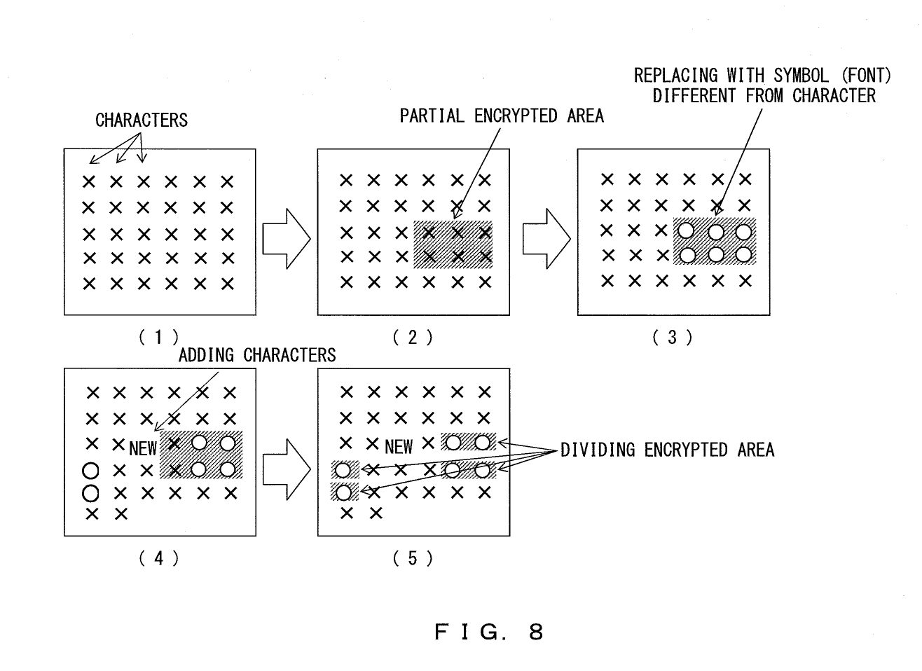

FIG. 8 is an example of a document image when the encrypted area is divided by editing the document data.

The mark “×” in FIG. 8 refers to a character. When the area indicated by the diagonal lines in FIG. 8 (2) is specified as an encrypted area, the characters in the area (indicated by “◯” in FIG. 8 (3)) are replaced by symbols etc. The method of encrypting document data can be a well known encrypting method for encrypting document data or a document image using an encryption key in addition to a method of replacing character data with other symbols.

Assume that, after an encrypted area is generated, the document data is edited, and a character (for example, “new”) has been added before the encrypted area. FIG. 8 (4) illustrates the state in which the editing operation of adding the characters “new” is performed on the document data. FIG. 8 (5) illustrates the state in which the edition contents have been determined. In this case, by adding the characters, there occurs a line shift by the characters in the encrypted area, and one encrypted area is divided into according to a plurality of encrypted areas. Dividing an encrypted area can be detected by the encrypted area trailing unit 15 checking a change in coordinates of the characters of the encrypted area.

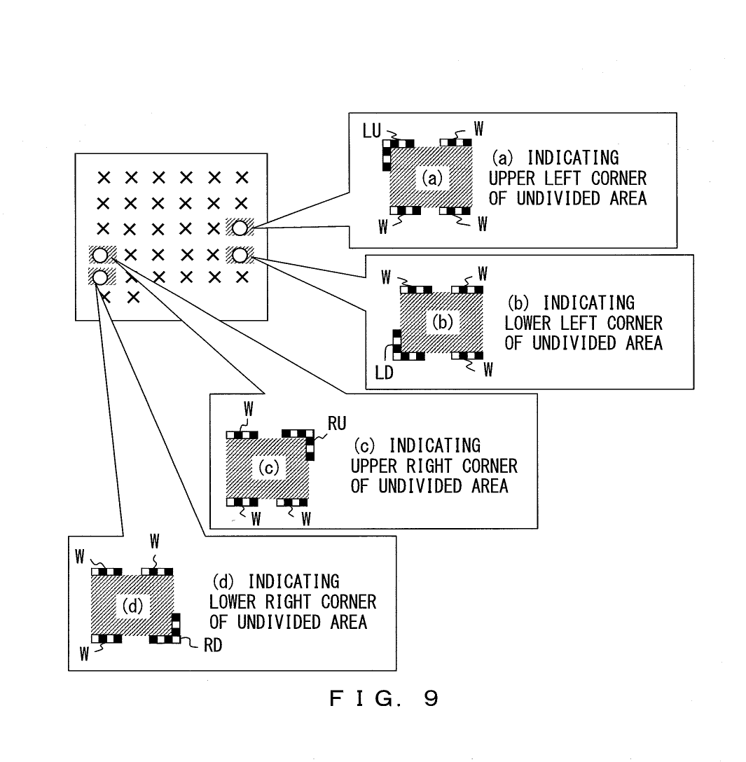

FIG. 9 is an explanatory view of the case in which a marker is added to a divided encrypted area. FIG. 9 is an example of the case in which a 4-character encrypted area is divided into four encrypted areas (a) through (d).

For the divided encrypted area (a), the upper left hooked marker LU indicating an undivided upper left corner encrypted area is arranged at the upper left corner position. To the other three corners, the linear marker W different from the hooked marker is added. The hooked marker LU has a pattern in which white and black are alternately arranged, and designates any position in the four corners.

For the divided encrypted area (b), the lower left hooked marker LD indicating an undivided lower left corner encrypted area is arranged at the lower left corner position.

To the other three corners, the linear marker W is added. For the divided encrypted area (c), the upper right hooked marker RU indicating an undivided lower upper right encrypted area is arranged at the upper right corner position. To the other three corners, the linear marker W is added.

For the divided encrypted area (d), the lower right hooked marker RD indicating an undivided lower right encrypted area is arranged at the lower right corner position. To the other three corners, the linear marker W is added.

When an encrypted area is divided, the marker indicating any of the upper left, upper right, lower left, and lower right areas of the undivided encrypted area is arranged at the corresponding position of the encrypted area to be divided. By arranging the markers at the divided encrypted area of a document image, the divided encrypted area can be reconstructed as an original encrypted area. For example, when a document image including a divided encrypted area is printed on paper etc., the undivided encrypted area can be reconstructed from the printed document image, and encrypted character data can be reconstructed.

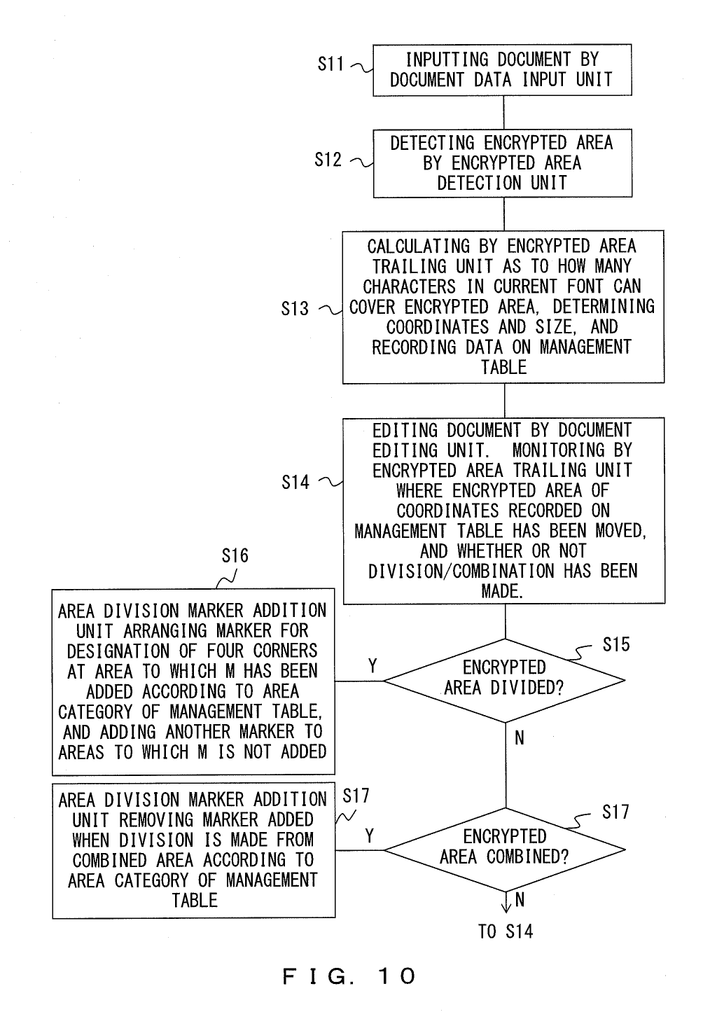

FIG. 10 is a flowchart of the encrypting process by the encryption device 11.

The document data input unit 12 inputs document data (S11). Next, the encrypted area detection unit 13 detects an encrypted area (S12).

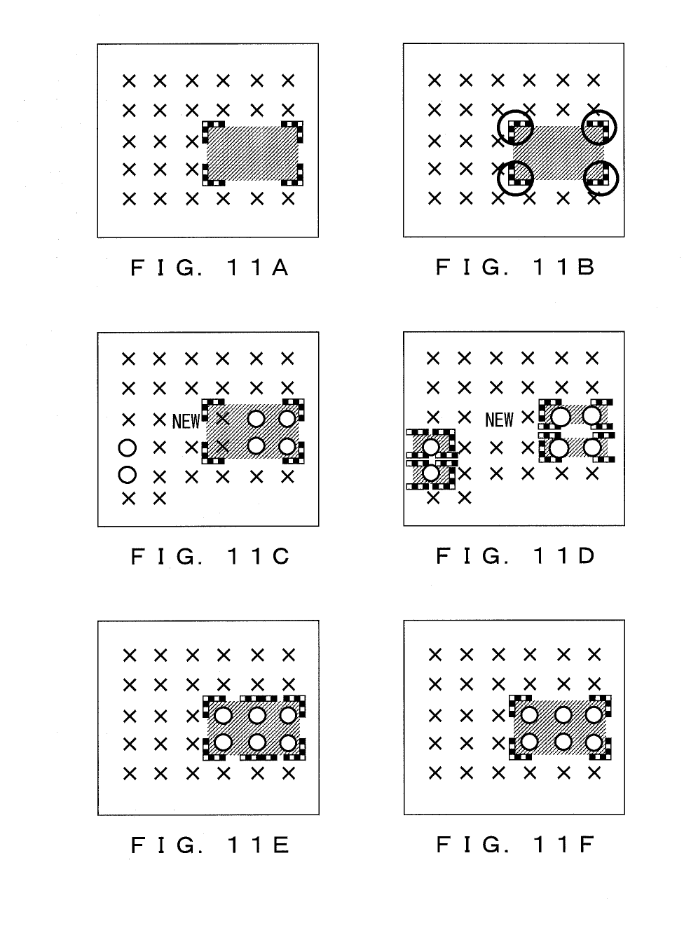

FIG. 11A is an example of input document data (document image). The hooked marker indicating the upper left corner, the hooked marker indicating the lower left corner, the hooked marker indicating the upper right corner, and the hooked marker indicating the lower right corner are arranged at the four corners of the encrypted area.

The process in step S12 detects an encrypted area by detecting the hooked markers of the four corners illustrated in FIG. 11B.

Next, the encrypted area trailing unit 15 calculates how many characters in the current font can cover the encrypted area, and records the data indicating the coordinates data and the size of each character area on the management table 21 (S13).

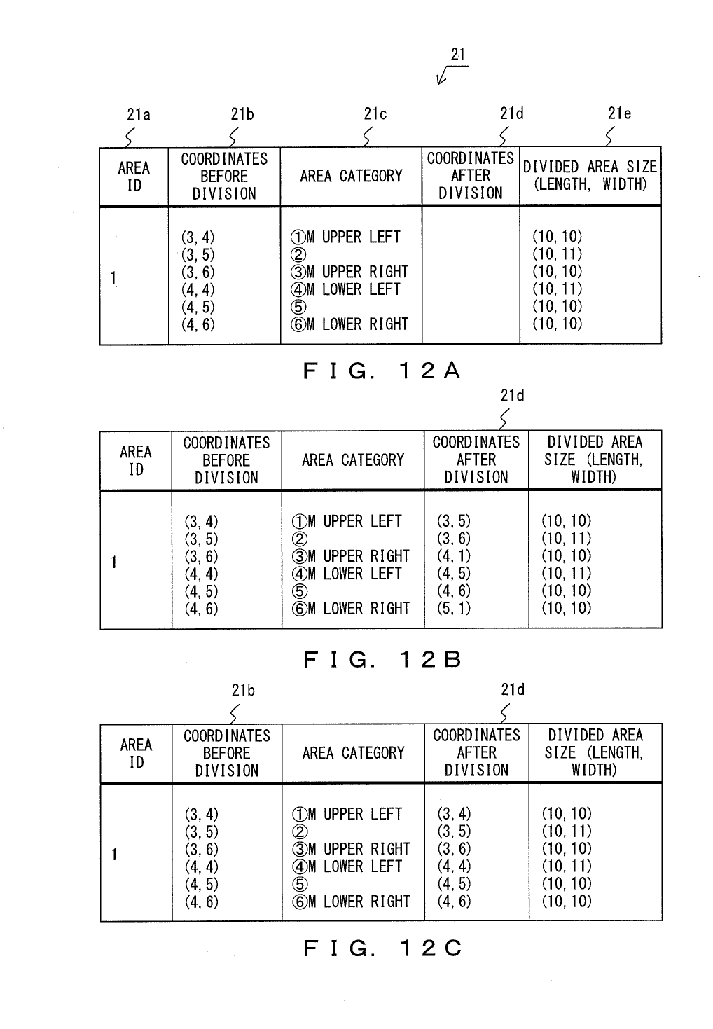

FIG. 12A is an example of the data of the management table 21 generated by the process in step S13.

In the process in step S13, the coordinates of the character area of the encrypted area are calculated, and the calculated coordinates data is recorded in the memory area 21b for storing the coordinates of the undivided area in the management table 21. The coordinates (3, 4) illustrated in FIG. 12A indicates the position on line 3, column 4 when the origin is assigned line 1, column 1 in the document data.

In the example in FIG. 11, the data “M upper left” indicating the upper left corner position of the encrypted area is associated with the coordinates data and stored. Likewise, the data indicating positions of the lower left corner, the upper right corner, and the lower right corner is associated with the coordinates data and stored. Furthermore, the size of each character area is calculated and stored as divided area sizes, for example, (10, 10), (10, 11) in the memory area 21e.

Back to FIG. 10, when the 14 edits document data, the encrypted area trailing unit 15 monitors with reference to the management table 21 whether or not the encrypted area has been moved, and whether or not the encrypted area has been divided or combined by the movement (S14).

Next, it is determined whether or not the encrypted area has been divided as a result of editing the document data (S15).

For example, as illustrated in FIG. 11C, when the characters “new” are inserted before the encrypted area, the encrypted area is shifted to the right, and the data in the last column of the encrypted area is moved to the line below (data indicated by o in the leading columns on lines 5 and 6 in FIG. 11C. Thus, the encrypted area is divided.

FIG. 12B is an example of the data of the management table 21 when the encrypted area is divided. If the encrypted area is divided as a result of editing the document data, the coordinates data after the division is added to the memory area 21d for storing the coordinates data after the division in the management table 21.

The encrypted area trailing unit 15 determines whether or not the encrypted area has been divided from the change of the coordinates data of the encrypted area.

If the encrypted area has been divided (YES in S15), control is passed to step S16, the area division marker adding unit 16 refers to the area category of the management table 21, and arranges a marker indicating any position of the four corners of the undivided encrypted area. That is, the marker (identification information) indicating the area of the upper left corner, the upper right corner, the lower left corner, or the lower right corner of the undivided encrypted area is arranged at the corresponding position of each of the divided encrypted areas. Furthermore, a marker different from the marker above indicating the four corners is added to the other corners.

By the process above in step S16, for example, the hooked marker indicating the upper left corner area is arranged at the position of the upper left corner of the divided encrypted area on top line as illustrated in FIG. 11D, and the linear marker is added to the other three corners. The hooked marker in another shape is arranged at the upper right corner position of the encrypted area at the left on one line below, and the linear marker is added to the other three corners. The same process is performed on the other divided encrypted areas.

When the encrypted area is not divided (NO in S15), control is passed to step S17, and it is determined whether or not the encrypted areas has been combined.

The determination as to whether or not the encrypted areas have been combined in step S17 can be realized by checking, for example, whether or not the coordinates of the two or more edited and encrypted areas are consecutive, whether or not the markers indicating the four corners match, etc.

When the encrypted areas are combined, the hooked markers are arranged at the four corners of the encrypted area obtained by combining the document images as illustrated in FIG. 11E, and the linear markers are left at the center.

FIG. 12C is an example of the data of the management table 21 when the four divided encrypted area are combined into one area.

When the four encrypted areas are combined by editing document data, as illustrated in FIG. 12C, the same coordinates data as the coordinates data (stored in the memory area 21b) of the undivided encrypted area is stored in the memory area 21d.

Back in FIG. 10, in step S17, if it is determined that the encrypted areas have been combined (YES in S17), control is passed to step S18, and the area division marker adding unit 16 removes the marker added when the division is made based on the area category in the management table 21. For example, when a plurality of encrypted areas are combined into one area by editing the document data, the identification information (marker) indicating the area of any of the upper left corner, the upper right corner, the lower left corner, and the lower right corner is left as is in the process in step S18, and the identification information (for example, a marker added when the division is made) different from the identification information about four corners is deleted.

In step S17, if it is determined that the encrypted area has not been combined (NO in S17), control is returned to step S14.

In the process in step S18 above, for example, as illustrated in FIG. 11F, the marker (for example, a linear marker W) added when the division is made is removed from the combined encrypted area.

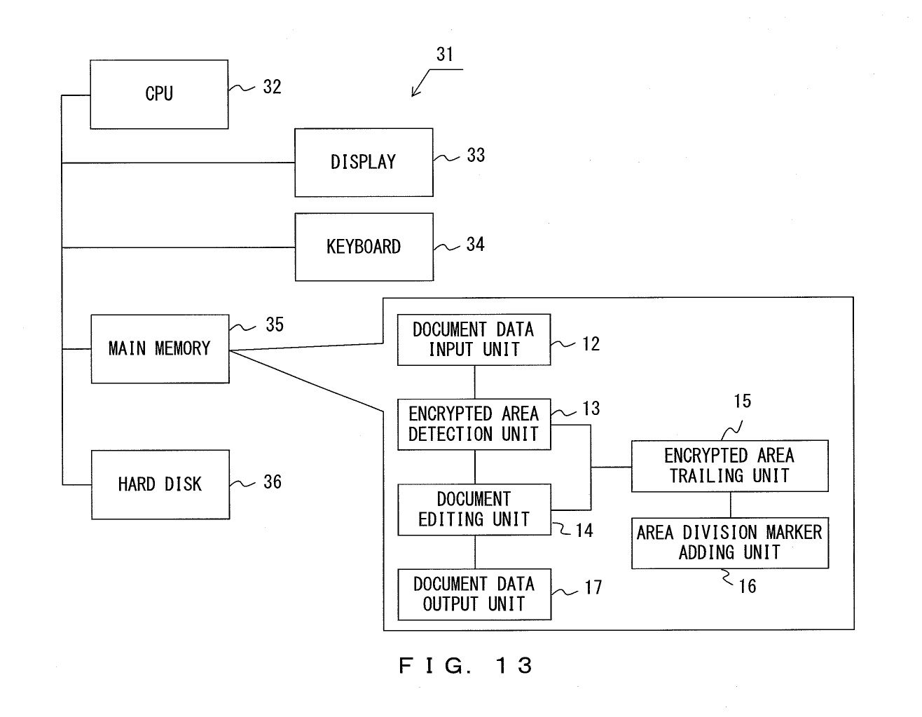

FIG. 13 is an example of the configuration of the information processing device implemented with the encrypting program of the above-mentioned document data. The information processing device is read by, for example, a personal computer.

A information processing device 31 includes a CPU 32, a display 33, a keyboard 34, main memory 35, and a hard disk 36.

The main memory 35 is loaded with an encrypting program for realizing the functions of the document data input unit 12, the encrypted area detection unit 13, the document editing unit 14, the encrypted area trailing unit 15, the area division marker adding unit 16, and the document data output unit 17 of the encryption device 11. The encrypting program is stored in the hard disk 36, and is loaded into the main memory 35 when the document data is encrypted.

By executing the encrypting program in the main memory 35, the document data (including a document image) including a divided encrypted area can be stored or output as document data which can be combined although an encrypted area is divided.

According to the first embodiment above, even when an encrypted area is divided by the operation of editing document data etc., the areas can be stored or output as document data or a document image with which the areas can be recombined. According to the first embodiment, for example, although a document image including a divided encrypted area is printed on paper, the undivided encrypted area can be reconstructed by detecting the identification information (marker etc.) arranged at the corner of the encrypted area of the printed document image, thereby decrypting the data of the reconstructed encrypted area.

In the first embodiment above, the hooked marker is used as a marker indicating the positions of the four corners of an undivided encrypted area, and the linear marker is used as a marker indicating the positions of the other corners, but other markers can be used. In addition, it is not necessary that a marker has a white and black pattern. Any data capable of recognizing a divided encrypted area as an area at any of the four corners of an undivided encrypted area can be used. For example, regardless of different shapes of markers, the markers of different patterns, colors, etc. are applicable, and code data is also acceptable.

In the example above, when an encrypted area is generated, a marker indicating any position of the four corners is added, but a marker only indicating the corner of the area can be added when an encrypted area is generated. When the encrypted area is divided, the area division marker adding unit 16 can arrange a marker indicating any area in the four corners of the undivided encrypted area at the corresponding position of the divided encrypted area.

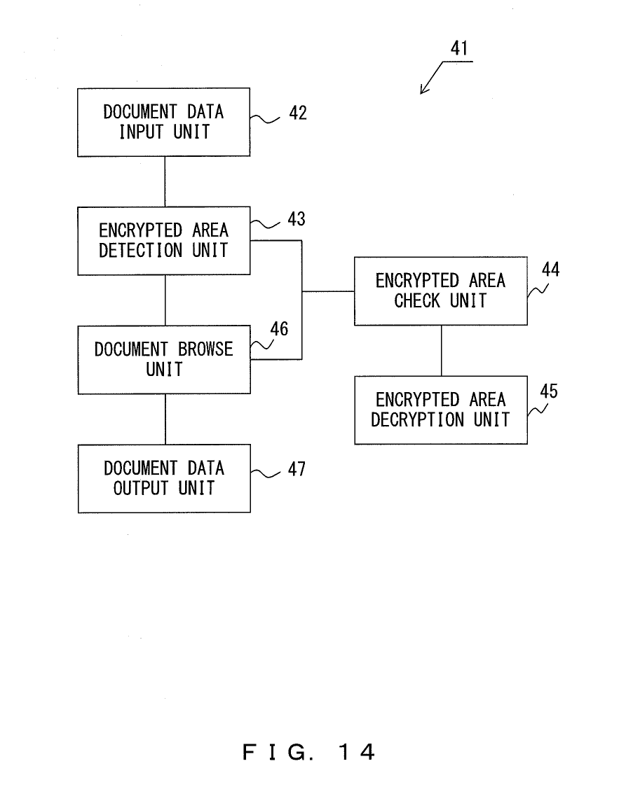

FIG.14 is an example of the configuration of a decryption device 41 of document data according to the second embodiment.

The decryption device 41 of document data includes a document data input unit 42, an encrypted area detection unit 43, an encrypted area check unit 44, an encrypted area decryption unit 45, a document browse unit 46, and a document data output unit 47.

The document data input unit 42 fetches document data to be decrypted. The document data input unit 42 is, for example, an input unit for fetching document data from a storage device etc., a scanner device for reading a printed document image. The document data input unit 42 has a storage device, and the input document image and document data are stored in the storage device.

The encrypted area detection unit 43 detects an encrypted area in the document data. An encrypted area can be detected by, for example, detecting a marker added at the position of the four corners of the encrypted area.

The encrypted area check unit 44 checks by the detected marker whether or not the encrypted area is a divided area. The encrypted area check unit 44 determines whether the marker indicating a corner of an encrypted area is a marker for designation of the four corners of an undivided encrypted area or a marker added when a division is made, and determines whether or not the encrypted area is a divided area. The encrypted area check unit 44 corresponds to a determination unit for determining a divided encrypted area according to identification information.

The encrypted area decryption unit 45 decrypts an encrypted area based on a check result of the encrypted area check unit 44. For example, when an area is determined as a divided encrypted area by the encrypted area check unit 44, the area is decrypted after recombining a plurality of encrypted areas.

The document browse unit 46 displays document data including an encrypted area or decrypted document data. The document data output unit 47 outputs a decrypted document data.

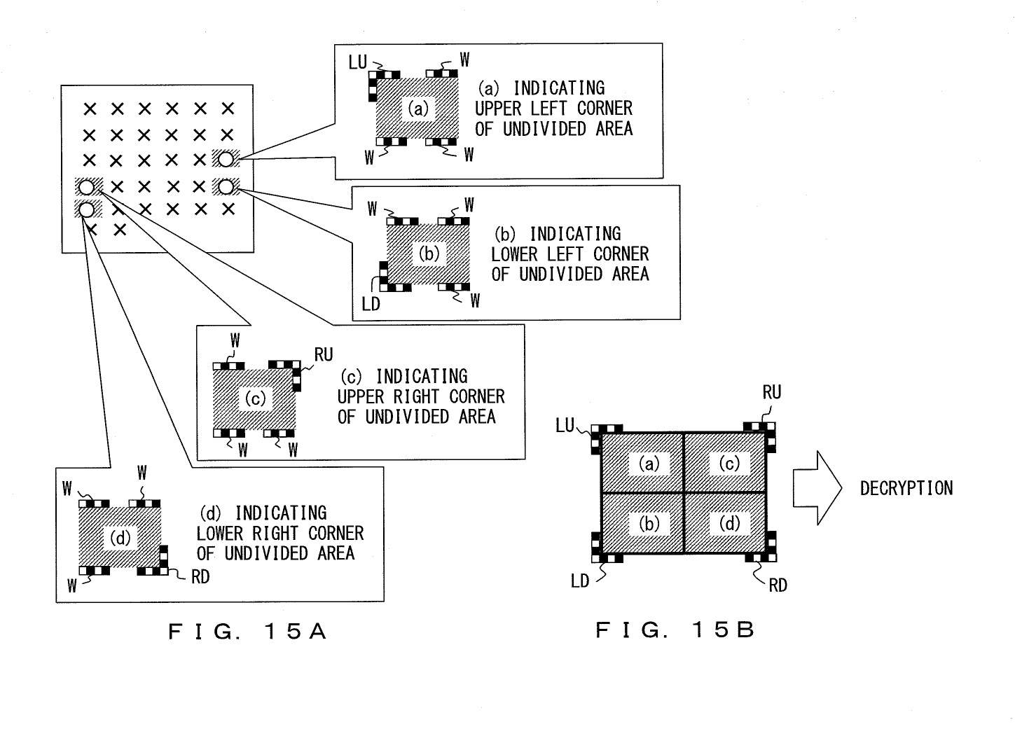

FIGS. 15A and 15B are an example in which the encrypted area of document data is divided into four areas. FIG. 15A illustrates a marker arranged at the corner of each divided encrypted area. FIG. 15B illustrates a recombined encrypted area.

The upper left hooked marker LU is arranged at the upper left corner position of the area (a) illustrated in FIG. 15A, and the linear marker W is arranged for the other corners. The hooked marker and the linear marker W have a pattern in which white and black are alternately arranged.

When the encrypted area check unit 44 recognizes that the hooked marker LU is arranged at the upper left corner of the area (a), and the linear marker W is arranged at the other corners, it determines that the area (a) is a divided encrypted area.

Likewise, the encrypted area check unit 44 recognizes that the lower left hooked marker LD is arranged at the lower left corner of the area (b), and the linear marker W is arranged at the other corners, it determines that the area (b) is a divided encrypted area.

Likewise, with the areas (c) and (d), the areas are determined as divided encrypted areas according to the hooked marker RD at the upper right corner position, the hooked marker RD at the lower right corner position, and the linear marker W.

Based on the four types of markers LU, LD, RU, and RD indicating the four corners of the original encrypted area detected by the encrypted area check unit 44, the encrypted area decryption unit 45 combines the data of the four encrypted areas (a) through (d) in the internal memory. Then, the data of the four encrypted areas (a) through (d) are combined to reconstruct one encrypted area illustrated in FIG. 15B.

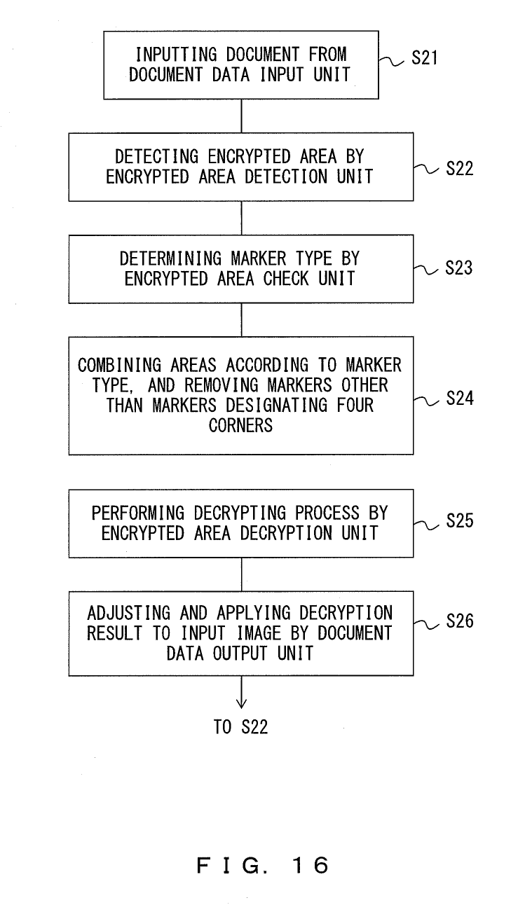

FIG. 16 is a flowchart of the decrypting process by the decryption device 41.

First, the document data input unit 42 inputs document data (S21). Next, the encrypted area detection unit 43 detects an encrypted area by detecting the markers arranged at the four corners of the area (S22).

Next, the encrypted area check unit 44 determines the type of the marker detected by the encrypted area detection unit 43 (S23). Furthermore, based on the type of the marker, it is determined whether or not the area is a divided encrypted area.

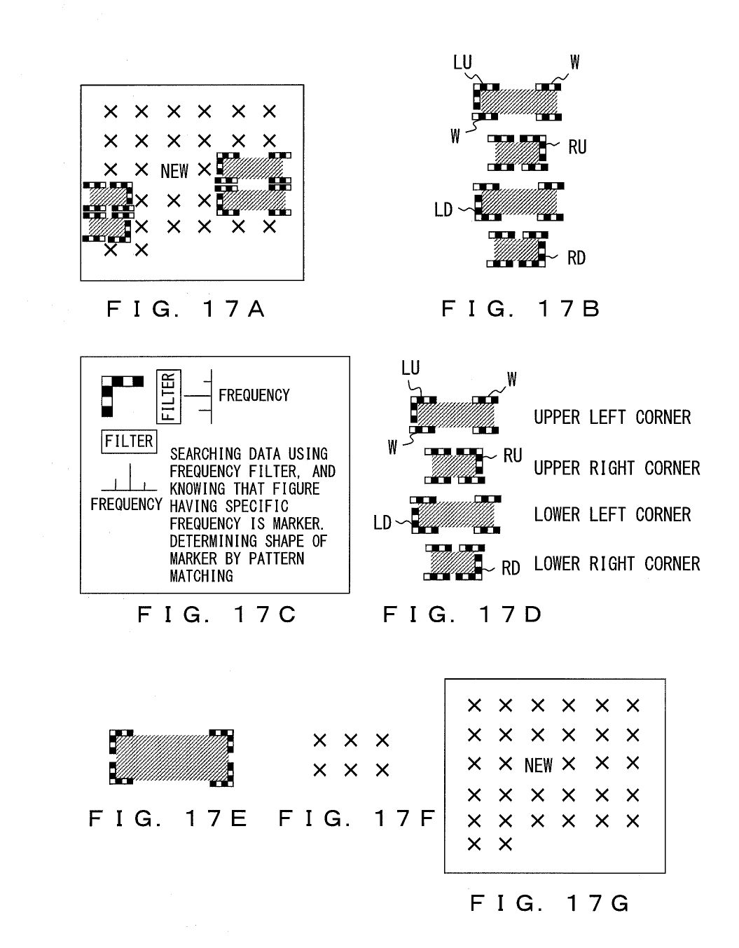

FIGS. 17A through 17G are an explanatory view of the contents of the decrypting process when the hooked marker and the linear marker are added to the corners of the encrypted area.

For example, assume that the document data including the divided encrypted area as illustrated in FIG. 17A has been input. In the process in step S22, the area for which markers are arranged as illustrated in FIG. 17B is extracted as an encrypted area. The markers are detected by searching the document image data using a frequency filter as illustrated in FIG. 17C and detecting a figure (having a frequency characteristic of a white and black pattern) having a specific frequency characteristic.

In the process of determining the type of marker in step S23, for example, it is determined whether the marker of the corner of the extracted encrypted area is a marker LU indicating the lower left corner, the marker RU indicating the upper right corner, the marker LD indicating the lower left corner, or the marker RD indicating the lower right corner. Furthermore, it is determined whether or not the marker of other corners is the linear marker W. In the determination of the type of marker, for example, the hooked marker is identified from the linear marker W by pattern matching.

In step S24 in FIG. 16, the encrypted areas are combined based on the type of marker, and the marker other than the marker designating the four corners is deleted.

FIG. 17E illustrates the state in which four encrypted areas are combined in the memory, the four hooked markers LU, RU, LD, and RD indicating the four corners are left as is, and the linear marker W is deleted.

In step S25 in FIG. 16, the encrypted area decryption unit 45 decrypts the recombined encrypted area.

The data indicated by “×” in FIG. 17F indicates the character data in the decrypted state by the process in step S25.

Next, in step S26 in FIG. 16, the document data output unit 47 adjusts and applies the decryption result to the input image (document image).

In the process in step S26, for example, as illustrated in FIG. 17G, the divided encrypted areas are combined into one area, decrypted, and displayed.

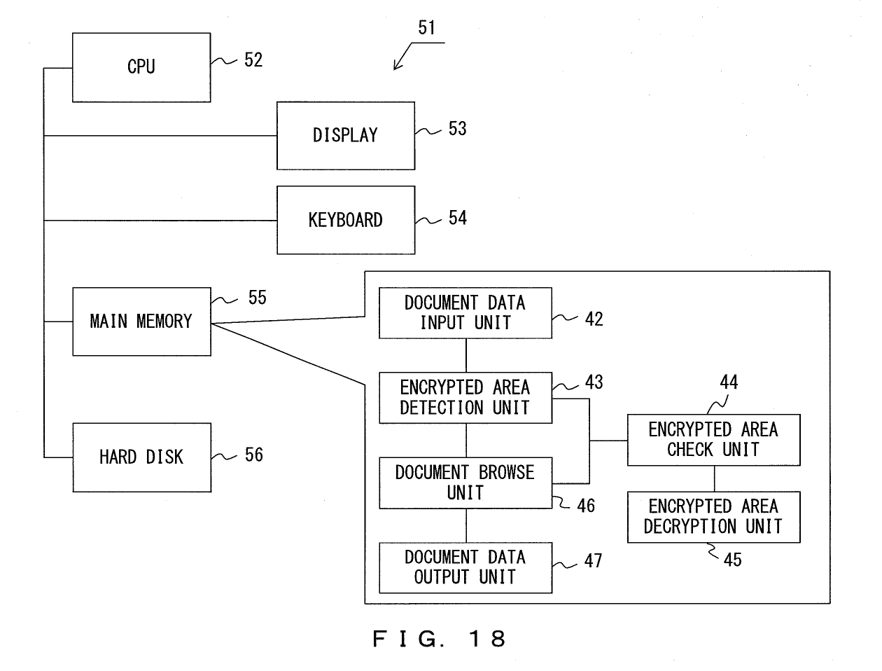

FIG. 18 is a configuration of the information processing device implemented with the above-mentioned decrypting program. The information processing device is realized by, for example, a personal computer.

An information processing device 51 includes a CPU 52, a display 53, a keyboard 54, main memory 55, and a hard disk 56.

The main memory 55 is loaded with a decrypting program for realizing the functions of the document data input unit 42, the encrypted area detection unit 43, the encrypted area check unit 44, the encrypted area decryption unit 45, the document browse unit 46, and the document data output unit 47 of the decryption device 41.

The decrypting program is stored in the hard disk 56, and loaded into the main memory 55 when a document image is decrypted.

By the CPU 52 executing the decrypting program loaded into the main memory 55 the divided encrypted areas are recombined to reconstruct the original document data.

According to the second embodiment above, although an area is divided into a plurality of encrypted areas by editing document data, the areas are recombined and the original document data can be reconstructed. For example, if a document image in which an encrypted area is divided is printed on paper etc., the printed document image is read by a scanner etc., and the divided encrypted areas can be recombined by detecting the markers arranged at the corners of the encrypted area of the read document image. Then, the original document image (or document data) can be reconstructed by decrypting the recombined encrypted area.

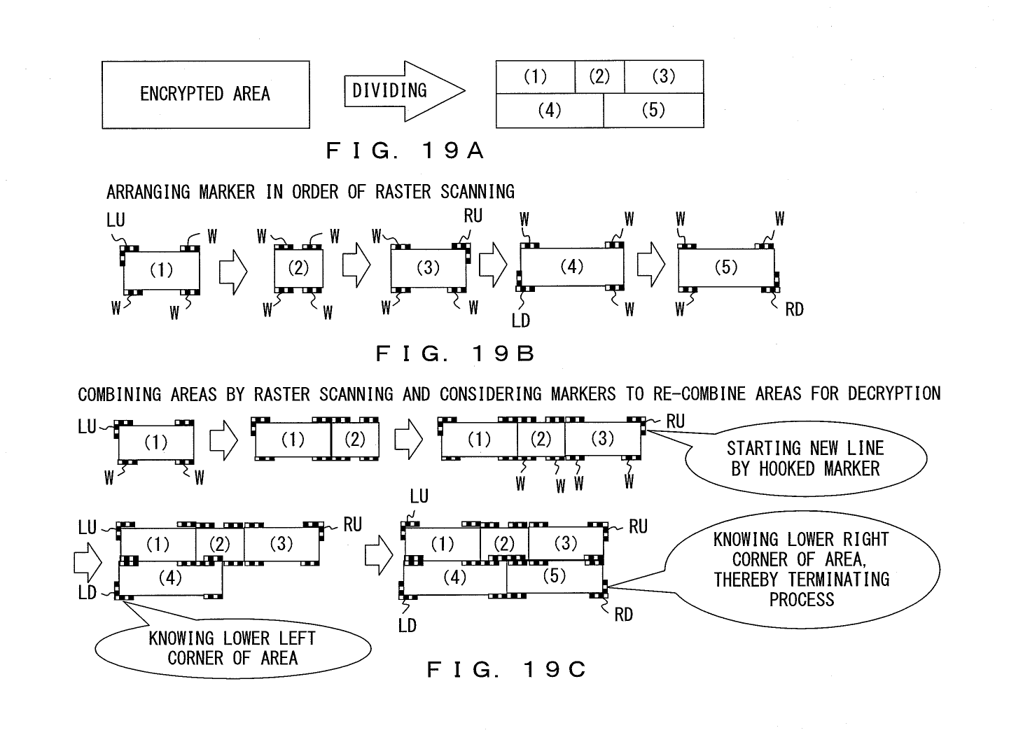

FIGS. 19A through 19C are explanatory views of the encrypting process and the decrypting process performed when the encrypted area of the document data is divided into five or more sections.

When the encrypted area is divided into five areas as illustrated in FIG. 19A, the image is scanned to right in the horizontal direction starting from the position of the upper left point of the document image, and is then scanned down in the vertical direction (raster scanning order), thereby sequentially setting the markers.

The area (1) illustrated in FIG. 19B is an upper left corner area of the undivided encrypted area, the hooked marker LU is arranged at the upper left corner position, and the linear marker W is newly added to the other corners.

Since the second area (2) from the left is not a corner area of the undivided encrypted area, the linear marker W is added to the positions of the four corners.

Since the third area (3) is an upper right corner area of the undivided encrypted area, the hooked marker RU is arranged at the upper right corner position, and the linear marker W is added to the other corners.

Since the fourth area (4) on one line below is a lower left corner area of the undivided encrypted area, the hooked marker LD is arranged at the lower left corner position, and the linear marker W is added to the other corners.

Since the fifth area (5) is a lower right corner area of the undivided encrypted area, the hooked marker RD is arranged at the lower right corner position, and the linear marker W is added to the other corners.

By the processes above, the encrypted area can be divided into five re-combinable encrypted areas.

Next, the contents of the process when the encrypted area which has been divided into five sections is recombined are described below with reference to FIG. 19C.

As in the case in which an encrypted area is divided, a scanning operation is performed from left to right in the horizontal direction, and is performed downward in the vertical direction (raster scanning), thereby recombining the areas.

The area (1) first detected by scanning an image in the horizontal and vertical directions as illustrated in FIG. 19C is provided with the upper left hooked marker LU at the upper left corner position, and the linear marker W is provided for the other corners. Therefore, it is determined that the area (1) is an upper left corner area of the undivided encrypted area. Since the second area (2) is provided with the linear marker W at the four corners, it is determined as an area other than the four corners. From the determination result above, the area (2) can be determined as an area following the area (1). Therefore, the areas (1) and (2) are combined.

The third area (3) is provided with the upper right hooked marker RU at the upper right corner position, and the linear marker W is arranged at the other corners. Therefore, the area (3) can be determined as an upper right corner area of the undivided encrypted area. Accordingly, the areas (2) and (3) are combined, and the new line is started immediately.

The fourth area (4) on the bottom line is provided with the lower left hooked marker LD at the lower left corner position, and the linear marker W at the other corners. Therefore, the area (4) can be determined as a lower left corner area of the undivided encrypted area. From the determination result, the area (4) is combined below the area (1).

The next area (5) is provided with the lower right hooked marker RD at the lower right corner position, and the linear marker W at the other corners. Therefore, the area (5) can be determined as the lower right corner area of the undivided encrypted area. From the determination result, the area (5) is combined to the area (4) on its right side.

By the processes above, the five divided encrypted areas are recombined, and the original encrypted area can be reconstructed.

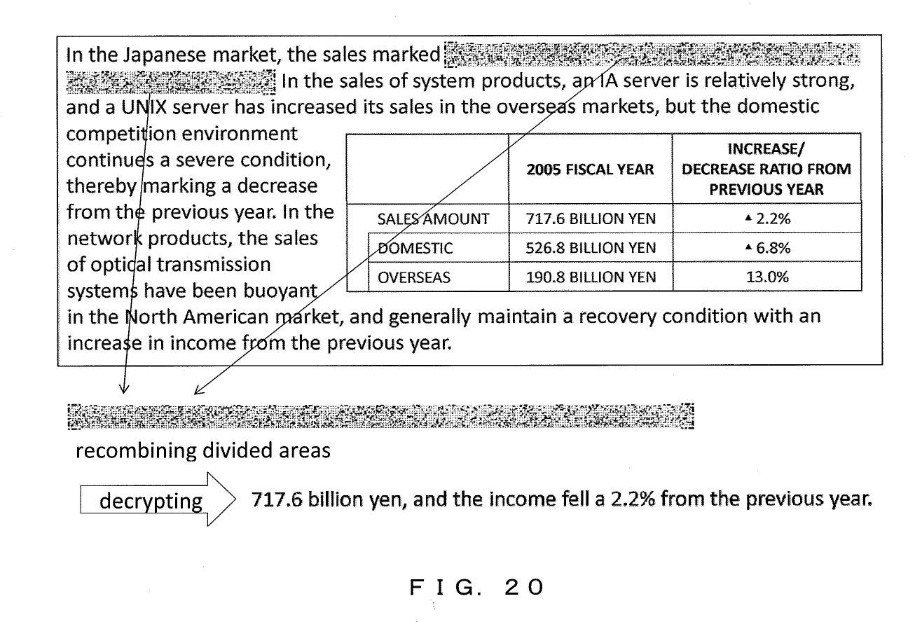

FIGS. 20 through 22 are examples of the divided encrypted area and the document data in which the divided encrypted area has been decrypted.

Although an encrypted area is divided as a result of editing document data, the divided encrypted areas can be recombined and decrypted as illustrated in FIG. 20 by executing the encrypting process according to the first embodiment and executing the decrypting process according to the second embodiment. As a result, as illustrated in FIG. 20, the characters “717.6 billion yen, and the income fell a 2.2% from the previous year.” in the re-combined encrypted area are decrypted and displayed.

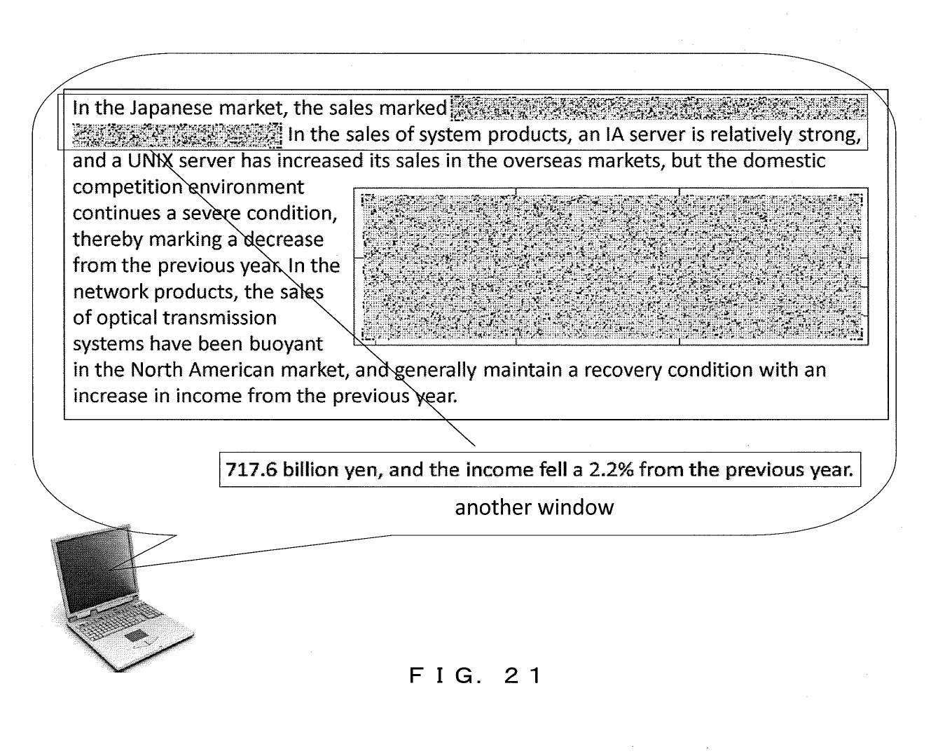

FIG. 21 is an example of displaying the case in which a divided encrypted area is re-combined and decrypted, and then displayed in another window.

In this case, the divided encrypted areas are recombined and decrypted, and the characters “717.6 billion yen, and the income fell a 2.2% from the previous year.” in the encrypted area are displayed in another window.

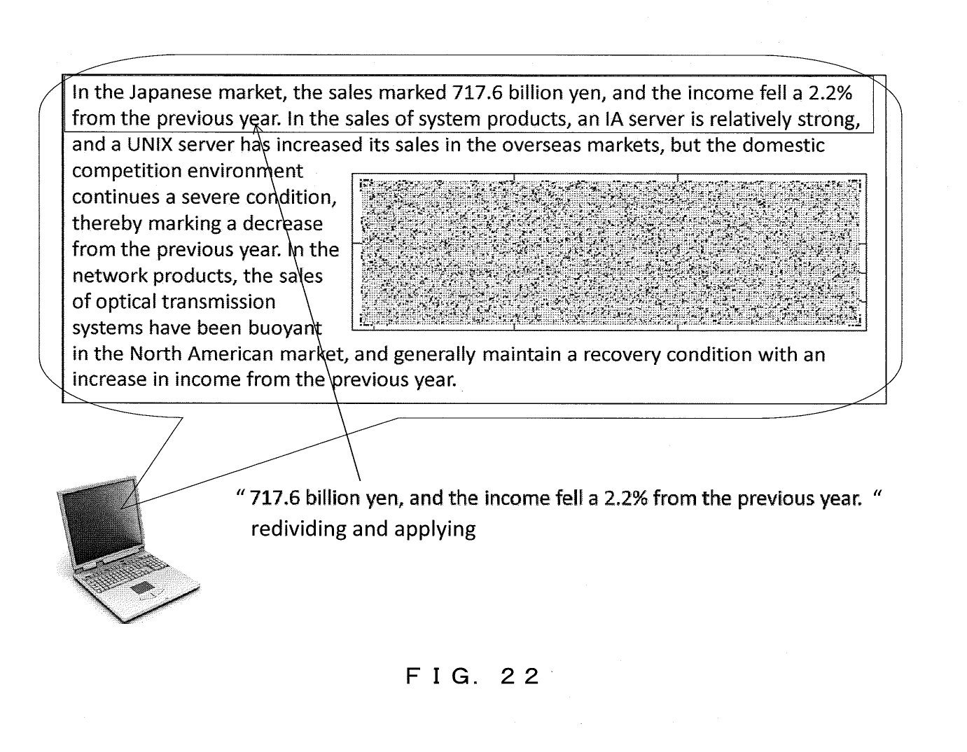

FIG. 22 is an example of displaying the case in which a divided encrypted area is recombined and decrypted, and then the decrypted characters are applied to the divided positions. In this case, the decrypted characters are displayed at the divided positions.

In the above-mentioned first and second embodiments, the encryption device 11 for encrypting document data and the decryption device 41 for decrypting encrypted document data are described, but the encrypting and decrypting functions can be incorporated into one device.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has (have) been described in detail, it should be understood that the various changes, substitutions, and alterations could be made hereto without departing from the spirit and scope of the invention.

What is claimed is:

1. An encryption device, comprising:
an encrypted area detection unit to detect an encrypted area from document data; and
an identification information setting unit to determine whether or not the encrypted area has been divided by an editing operation on the document data, and to set identification information indicating any position of four corners of an undivided encrypted area at a corresponding position of each of the divided encrypted areas if the encrypted area has been divided.

2. The device according to claim 1, wherein
the identification information setting unit sets the identification information indicating upper left corner, upper right corner, lower left corner, or lower right corner of an undivided encrypted area at a corresponding position of a divided encrypted area.

3. The device according to claim 1, wherein
the identification information setting unit arranges the identification information indicating any area of an upper left corner, an upper right corner, a lower left corner and a lower right corner in an undivided encrypted area at a corresponding position in four corners of a divided encrypted area, and arranges identification information different from the identification information above at other corners.

4. The device according to claim 1, wherein
the document data is a document image, and the identification information setting unit arranges a marker indicating any area of an upper left corner, an upper right corner, a lower left corner, and a lower right corner of an undivided encrypted area as the identification information at a corresponding position in four corners of a divided encrypted area, and arranges a marker different from the marker above at other corners.

5. The device according to claim 1, further comprising:
a management table generation unit to generate a management table in which an area ID for designation of an encrypted area, coordinates data indicating a position of the encrypted area, and the identification information indicating any position of four corners are associated, and to store the associated data in a storage device, wherein
when an encrypted area is divided by editing document data, the management table generation unit stores the coordinates data of a divided encrypted area with area information for designation of an encrypted area before the management table, the coordinates of an undivided encrypted area, and the identification information indicating any position of four corners of an undivided encrypted area associated with one another.

6. The device according to claim 1, wherein
the encrypted area detection unit detects an encrypted area by detecting the identification information indicating an upper left corner, an upper right corner, a lower left corner, and a lower right corner of an encrypted area.

7. The device according to claim 1, wherein
the identification information setting unit leaves identification information indicating an area of an upper left corner, an upper right corner, a lower left corner, or a lower right corner of a divided encrypted area and deletes identification information different from the identification information about the four corners when a plurality of encrypted areas are combined into one area by editing document data.

8. A decryption device, comprising:
an encrypted area detection unit to detect an encrypted area from document data;
a determination unit to determine whether or not an area is a divided encrypted area depending on whether or not identification information indicating any position of four corners of an undivided encrypted area is arranged at a corner of the encrypted area detected by the encrypted area detection device and information different from the identification information is arranged at other corners; and
a decryption unit to combine a plurality of encrypted areas divided according to the identification information indicating any position of the four corners when the determination unit has determined the divided encrypted area, and decrypting the combined encrypted areas.

9. The device according to claim 8, wherein
the determination unit determines whether or not the encrypted area is a divided encrypted area depending on whether or not the identification information indicating an area of an upper left corner, an upper right corner, a lower left corner, or a lower right corner of an undivided encrypted area is arranged at a position of a corner of the encrypted area, and whether or not identification information different from the identification information is arranged at other corners.

10. A method of encrypting document data, comprising:
detecting an area encrypted from document data stored in a storage device; and
determining whether or not an encrypted area has been divided by an editing operation on the document data, and setting identification information indicating any position of four corners of an undivided encrypted area at a corresponding position of each of encrypted areas when the encrypted area is divided.

11. The method according to claim 10, wherein
the identification information for designation of an upper left corner, an upper right corner, a lower left corner, or a lower right corner of an undivided encrypted area is arranged at a corresponding position of an divided encrypted area, and identification information different from the identification information is added to other corners.

12. The method according to claim 10, wherein
when a plurality of encrypted areas are combined into one area, identification information indicating an area of an upper left corner, an upper right corner, a lower left corner, or a lower right corner of a divided encrypted area is left, and identification information different from the identification information about four corners is deleted.

13. A method of decrypting document data, comprising:
detecting an area encrypted from document data stored in a storage device;
determining whether or not the detected area is a divided encrypted area depending on whether or not identification information indicating any position of four corners of an undivided encrypted area is arranged at a corner of the detected encrypted area, and whether or not identification information different from the identification information above is arranged at other corners; and
combining a plurality of divided encrypted areas according to the identification information indicating any of four corners, and decrypting the combined encrypted area when the area is determined as a divided encrypted area.

14. The method according to claim 13, wherein
it is determined whether or not the encrypted area is a divided encrypted area depending on whether or not the identification information indicating an area of an upper left corner, an upper right corner, a lower left corner, or a lower right corner of an undivided encrypted area is arranged at a position of a corner of an encrypted area, and whether or not identification information different from the identification information above is arranged at other corners.
